(19) United States
(12) Patent Application Publication
(10) Pub. No.: US 2009/0256299 A1
(43) Pub. Date: Oct. 15, 2009

(54) LOCKING MECHANISM OF A WORKTABLE OF A DRILLING MACHINE

(76) Inventor: CHING-SHAN LING, Taichung City (TW)

Correspondence Address: Chien-Hui Su, P. O. Box 70-121 Taichung, Taichung City, 40899, TW

(21) Appl. No.: 12/101,106

(22) Filed: Apr. 10, 2008

(51) Int. Cl. B23Q 1/26

(52) U.S. Cl. 269/74; 408/87; 70/183

(57) ABSTRACT

A locking mechanism of a worktable for a drilling machine includes: a worktable has a loading surface formed on a top thereof for loading. A space is defined in the worktable and a wire coil is received therein. A spindle is longitudinally and centrally mounted to a bottom of the worktable. A connecting portion is mounted onto a periphery of the spindle and includes a locating assembly and a conducting assembly mounted in the locating assembly for electrically connecting the wire coil. The locating assembly has at least one fixing hole defined therein. And at least one fixing rod is mounted into the fixing hole for fixing the locating assembly and maintaining the electromagnetic field.

### FIELD OF THE INVENTION

The present invention relates to a locking mechanism, particularly to a locking mechanism of a worktable of a drilling machine for fixing the workpiece and assembling a drilling machine easily.

### BACKGROUND OF THE INVENTION

In the past, as FIG. 13 shows, a drilling machine 5 for drilling various size of workpieces (e.g. iron plate, steel materials, mold plate, machine component), if the workpiece is small, it needs to use a vice or other equipments for fixing the small workpiece above a worktable 4, so the workpiece is fastened above the worktable 4 for staring the drilling process, but there are too many steps to accomplish a simple drilling work. As a result, there is an improvement using the electromagnet for fixing the workpiece.

As FIG. 14 shows, inside of a worktable 6 of a drilling machine 7 has some wire coils disposed therein for producing electromagnetic field, but the worktable 4 should be rotated for suit all kinds of situation and checking the drilling part of the workpiece, it is very easy to form an open circuit that fails to produce the electromagnetic field when the worktable 6 is rotated, so a special design for rotating and adjusting should be installed in the worktable 6 is required.

One part of the worktable 6 should be fixed with the drilling machine 7 for electrically connecting the wire coils to be a close circuit for producing the electromagnetic field, the other part of the worktable 6 is needed to be rotated for adjusting the workpiece; further, the worktable 6 should be matched different specifications of the drilling machine 7 for increasing applicability of the worktable 6.

It uses the bolts axially screwed into the worktable of the conventional locking mechanism for fixing the worktable in case of rotating, but the design of the conventional locking mechanism is too complicated to be assembled or disassembled; there are a lot of limitation for matching the difference specification of the drilling machine. Otherwise, the size of a spindle of the worktable of the conventional locking mechanism is limited by the complicated assembly, and one worktable of the conventional locking mechanism can only match one specification of the drilling machine.

Thus there is an eager demand for a novel design which can improve the defect in the conventional locking mechanism.

### SUMMARY OF THE INVENTION

The present invention overcomes the disadvantages of the prior art by providing a locking mechanism of a worktable for a drilling machine, the locking mechanism in accordance with the present invention comprises: a worktable having a loading surface formed on a top thereof for loading. a space is defined in the worktable and a wire coil is received in the space for producing a electromagnetic field. A spindle is longitudinally and centrally mounted to a bottom of the worktable for assembling a drilling machine. A connecting portion is mounted onto a periphery of the spindle and includes a locating assembly and a conducting assembly mounted in the locating assembly for electrically connecting the wire coil. The locating assembly has at least one fixing hole defined therein. And at least one fixing rod is mounted into the fixing hole for fixing the locating assembly and maintaining the electromagnetic field.

The structure of the present invention is simple for assembling and disassembling by a user; whereby the fixing rod is adjusted for corresponding different diameters of the axle sleeves and adapting all kind of drilling machines.

The various objectives and advantages of the present invention will be more readily understood from the following detailed description when read in conjunction with the appended drawing.

### BRIEF DESCRIPTION OF THE DRAWINGS

FIG. 1 is an exploded perspective view of a locking mechanism of a worktable of a drilling machine in accordance with the present invention;

FIG. 2 is a partially exploded plan view of the locking mechanism in partial cross-section;

FIG. 3 is a perspective view of a worktable, a protecting assembly and a working arm of the locking mechanism of the present invention;

FIG. 4 is an exploded perspective view of a worktable, a protecting assembly and a working arm of the locking mechanism of the present invention;

FIG. 5 is an operation view of the locking mechanism of the present invention;

FIG. 6 is perspective view of a first embodiment of the locking mechanism in accordance with the present invention;

FIG. 7 is a partially plan view of the first embodiment of the locking mechanism in partial cross-section;

FIG. 8 is perspective view of a second embodiment of the locking mechanism in accordance with the present invention;

FIG. 9 is an operation view of a second embodiment of the locking mechanism in accordance with the present invention;

FIG. 10 is perspective view of a second embodiment of the worktable in accordance with the present invention;

FIG. 11 is perspective view of a third embodiment of the worktable in accordance with the present invention;

FIG. 12 is an exploded perspective view of a forth embodiment of the worktable in accordance with the present invention;

FIG. 13 is a conventional perspective view of a worktable of a drilling machine in accordance with the prior art; and

FIG. 14 is a conventional perspective view of a worktable using electromagnetic in accordance with the prior art.

### DETAILED DESCRIPTION OF THE INVENTION

In order that those skilled in the art can further understand the present invention, a description will be provided in details below. However, these descriptions and the appended drawings are only used for those skilled in the art to understand the objects, features, and characteristics of the present invention, but not to be used to confine the scope and spirit of the present invention defined in the appended claims.

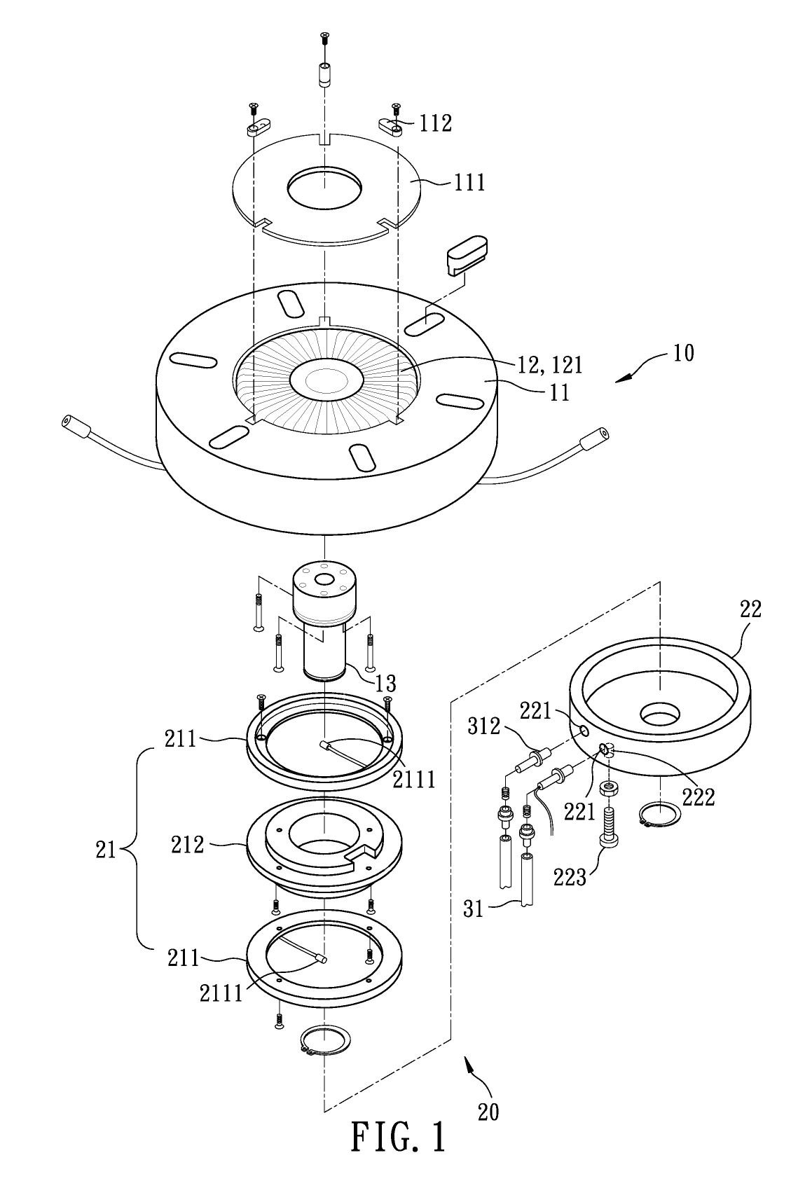

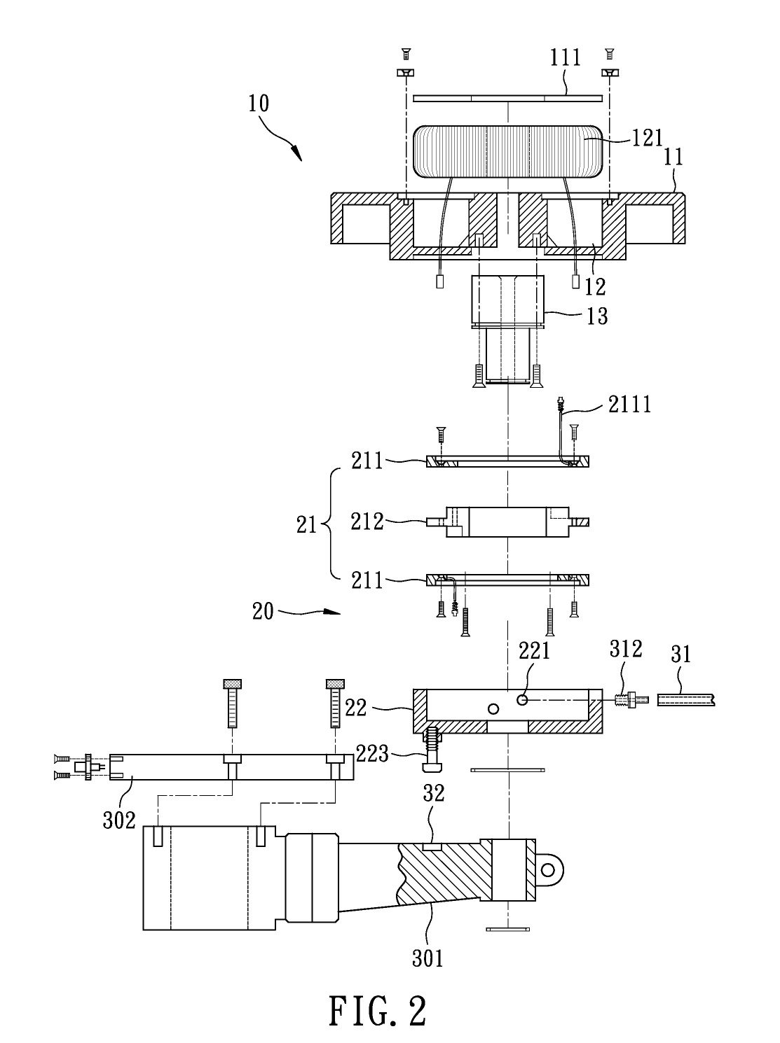

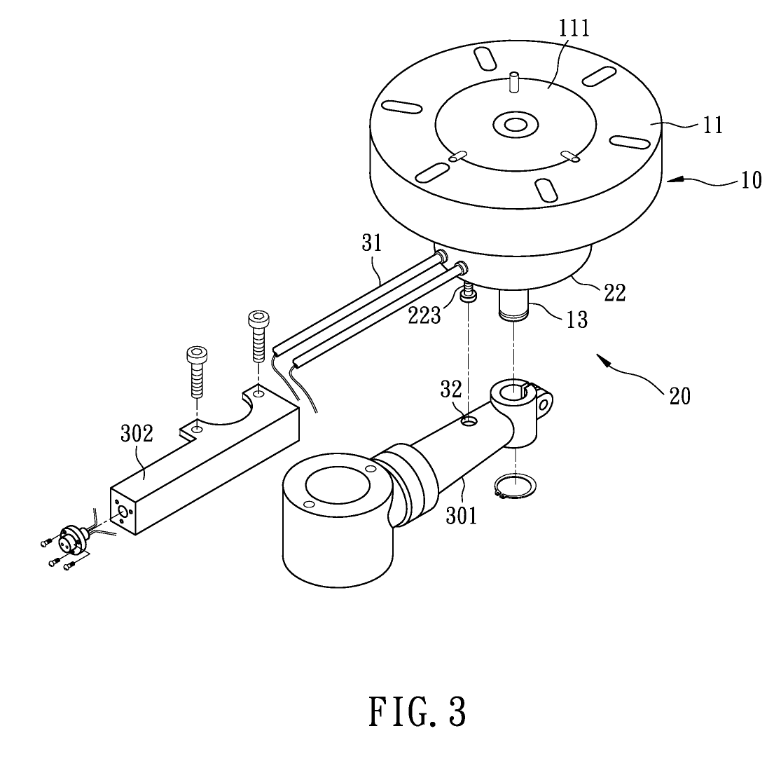

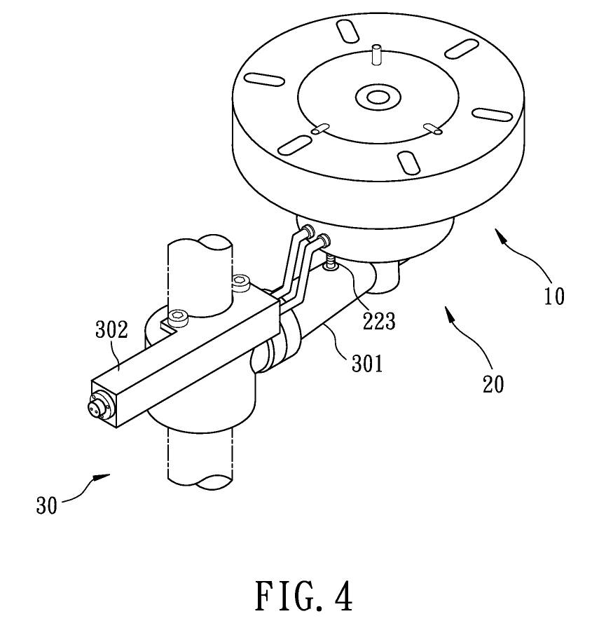

Referring FIG. 1 to FIG. 5, a locking mechanism of a worktable 10 for a drilling machine according to the present invention is illustrated.

The locking mechanism of the present invention has the following elements.

A worktable 10 is adapted to be mounted to the drilling machine and includes, a loading surface 11 is formed on a top of the worktable 10 for loading a workpiece (not shown). A copper plate 111 is installed on the loading surface 11, a space 12 is centrally defined in the worktable 10 and, a wire coil 121 is received in the space 12. Multiple blocks 112 are mounted on the loading surface 11 and surround the copper plate 111 for selectively locking the copper plate 111 that is disposed above the wire coil 121. The wire coil 121 has two opposite poles respectively connected to an extra power source for producing electromagnetic field, thus the worktable 10 can use the electromagnetic field to attract workpiece that is made of magnetic material. It also can use a vise to grip the workpiece and the worktable 10 attracts the vice for drilling.

A spindle 13 is centrally and longitudinally mounted to a bottom of the worktable 10 and rotates co-axially with the worktable 10. A lower part of the spindle 13 is installed in a working arm 301 that is adapted to be connected to the drilling machine.

A connecting portion 20 is mounted onto the periphery of an upper part of the spindle 13 and nearby the wire coil 121 in the worktable 10. The connecting portion 20 includes a locating assembly 22 and a conducting assembly 21 mounted in the locating assembly 22. The conducting assembly 21 is rotated co-axially with the spindle 13. The conducting assembly 21 includes two conducting rings 211 and an insulating ring 212 sandwiched between the two conducting rings 211 such that the two conducting rings 211 are insulated relative to each other due to the insulating ring 212. Each conducting ring 211 has a conducting wire 2111 electrically connected thereto. Each conducting wire 2111 is electrically connected to a corresponding one of two poles of the wire coil 121.

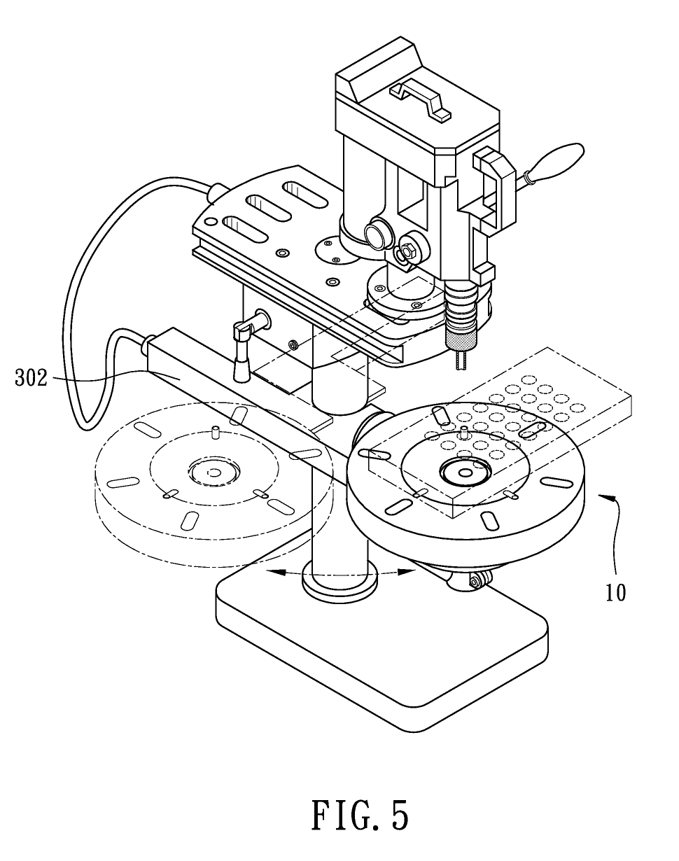

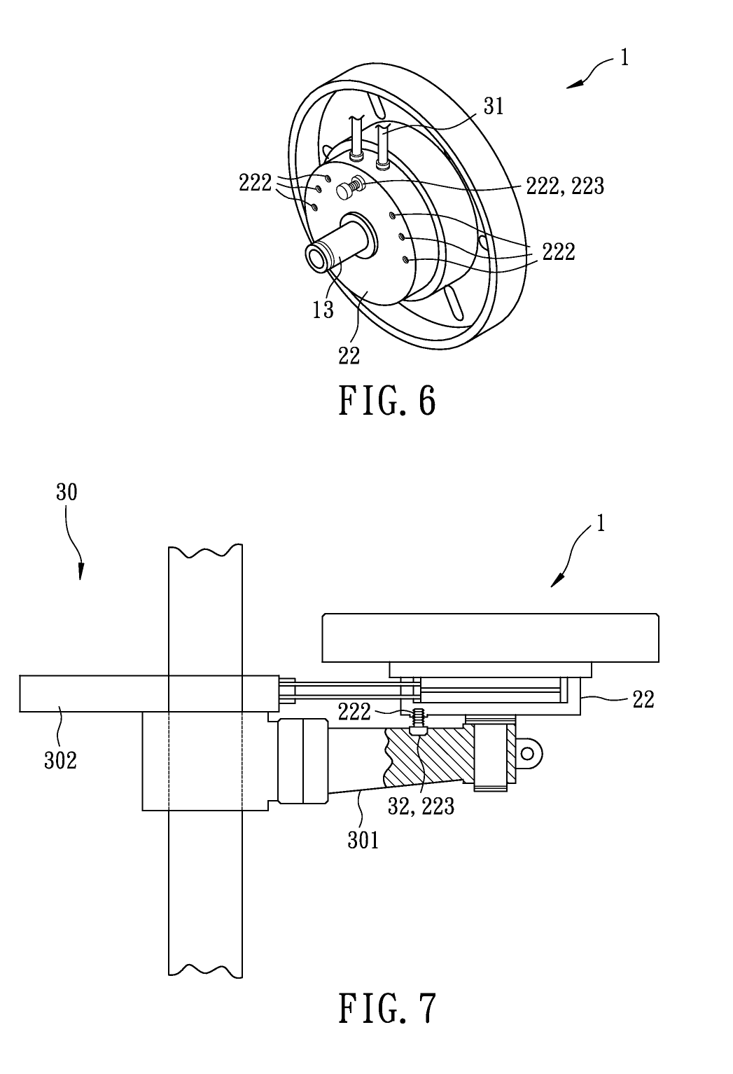

An opening is centrally defined in the locating assembly 22 to allow and receive the spindle 13 extending through the locating assembly 22. A C-shaped ring locks a bottom of the spindle 13 in the locating assembly 22. The locating assembly 22 has two holes 221 laterally defined therein for receiving two conducting blocks 312 from a protecting assembly 302 that is mounted on the working arm 301. Two electric wires 31 are longitudinally mounted in the conducting blocks 312 with respectively for connecting the two conducting ring 211. As shown in FIG. 5 shows, the protecting assembly 302 protects the two electric wires 31 from falling from the connecting portion 20 when the worktable 10 is rotated. With reference to as FIG. 6 and FIG. 7 that show a first embodiment of the locking mechanism according to the present invention, the locating assembly 22 has at least one fixing hole 222 defined therein. In the preferred embodiment of the present invention, the locating assembly 22 has seven fixing holes 222. At least one fixing rod 223 is mounted into a corresponding one of the seven fixing holes 222 and locks above the working arm 301. The working arm 301 has a slot 32 defined therein and corresponding to the fixing rod 223, whereby the locating assembly 22 does not rotate with the worktable 10 and the conducting assembly 21 for connecting respectively the two electronic wire 31 and the two conducting ring 211 and maintaining the electromagnetic field when the extra power source electrically connects to the wire coil 121.

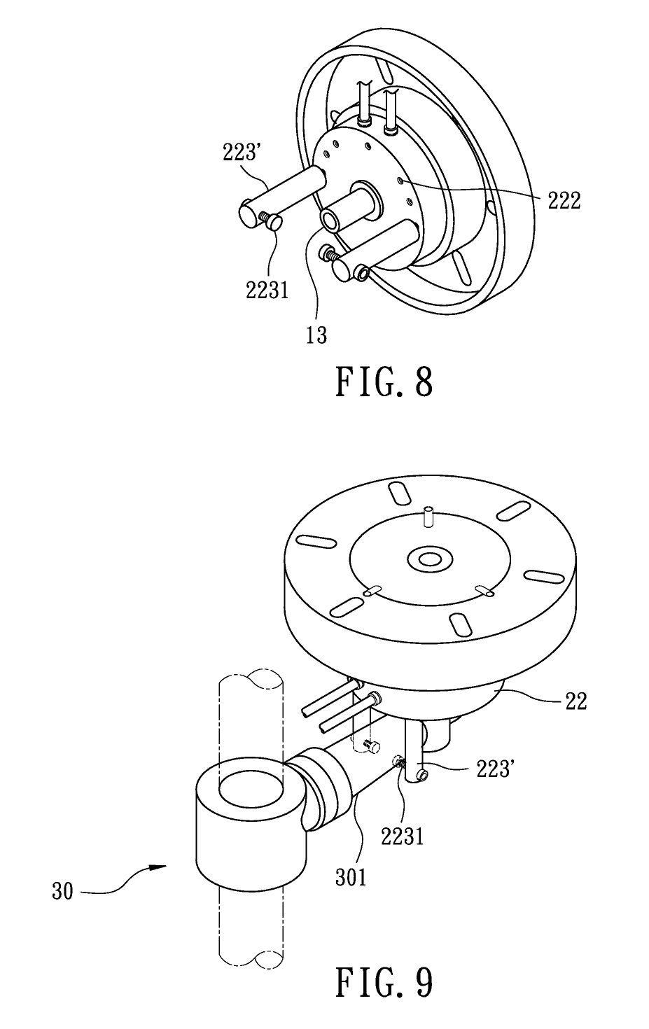

With reference to FIG. 8 and FIG. 9 that show a second embodiment of the locking mechanism in accordance with the present invention, in the embodiment, there are two fixing rods 223′ each having a locking member 2231 diametrically mounted thereon for laterally gripping the working arm 301 and fixing the locating assembly 22, further more, the two fixing rods 223′ provide a better fixing effect to the working arm 301 of the second embodiment according to the present invention.

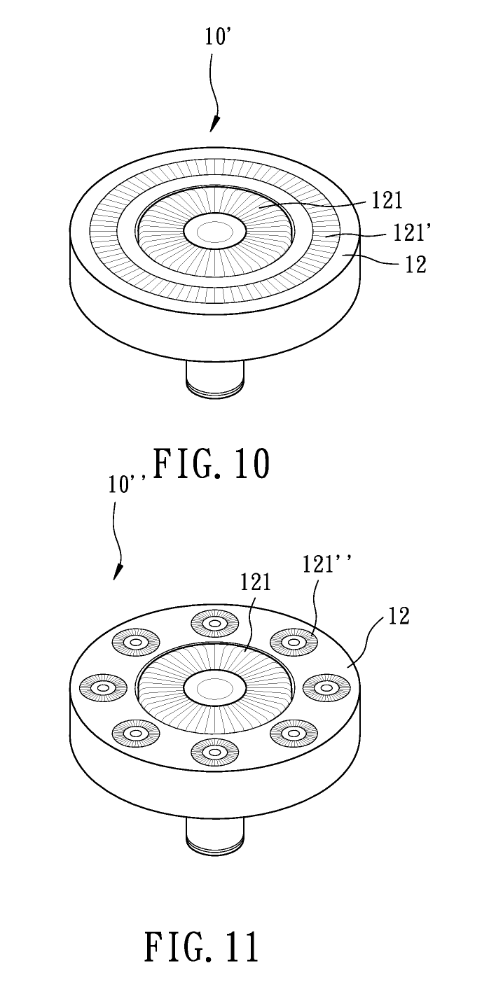

With reference to FIG. 10 that shows a second embodiment of the worktable 10′ of the present invention, in the embodiment, the worktable 10′ further comprises a circular coil 121′ buried therein and surrounding the wire coil 121 for increasing an effective area of the electromagnetic field. With reference to FIG. 11 that shows a third embodiment of the worktable 10″ of the present invention, in the embodiment, the worktable 10″ has multiple secondary coils 121″ buried therein and equally surrounding the wire coil 121 for increasing an effective area of the electromagnetic field.

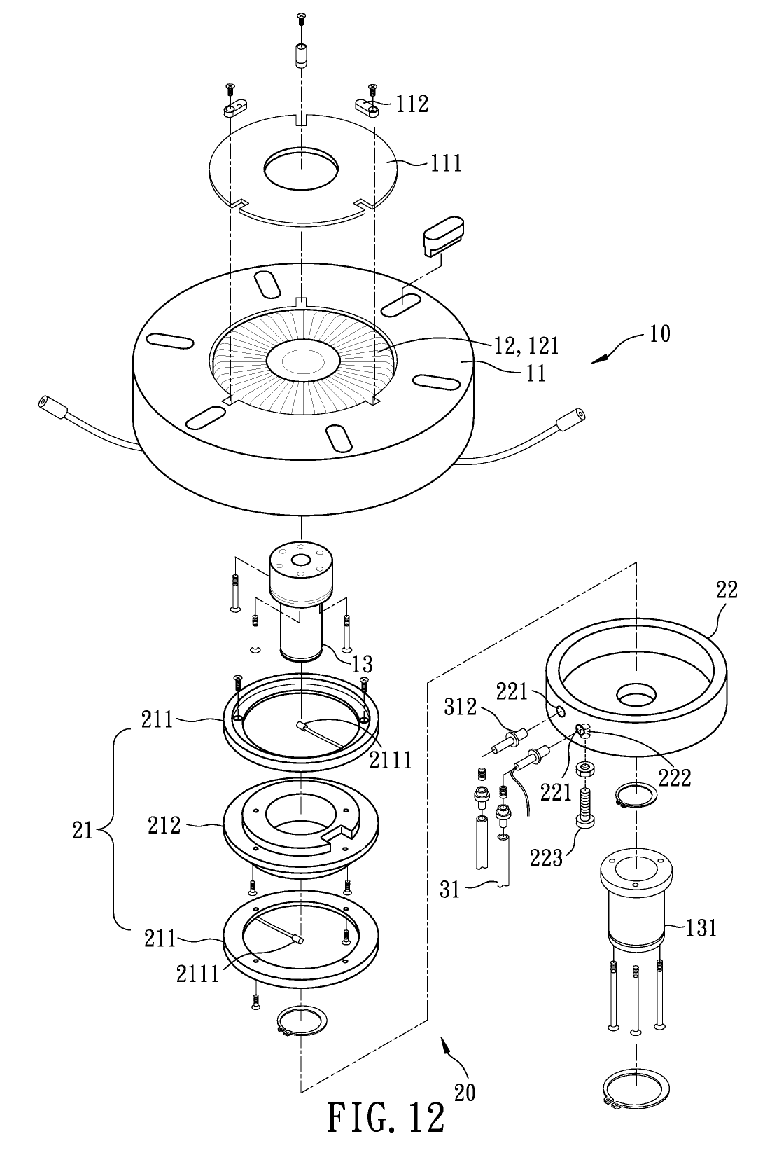

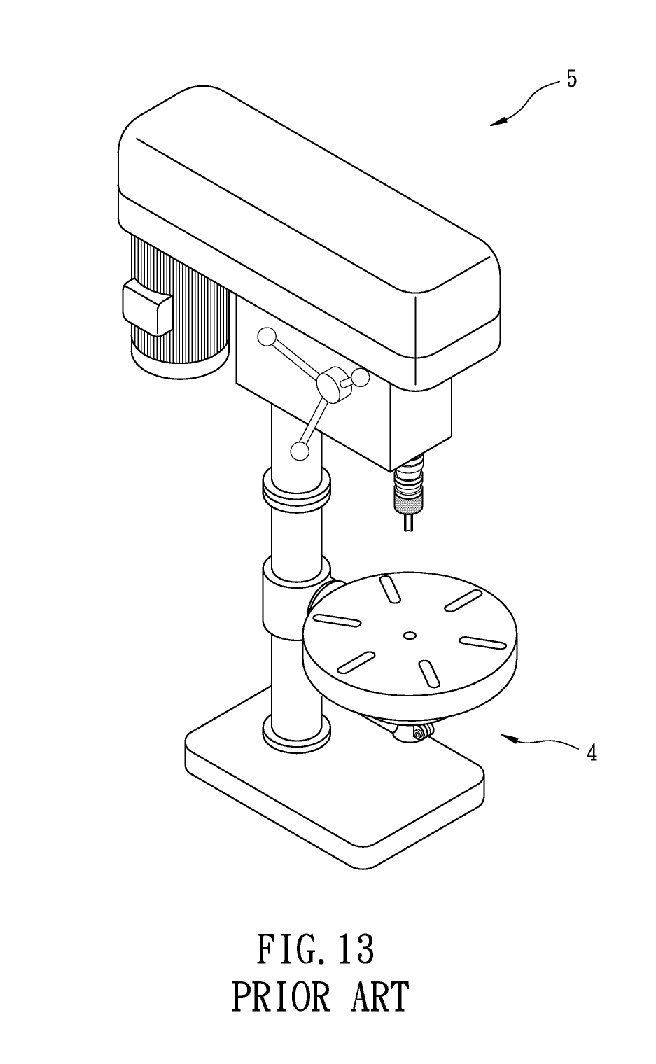

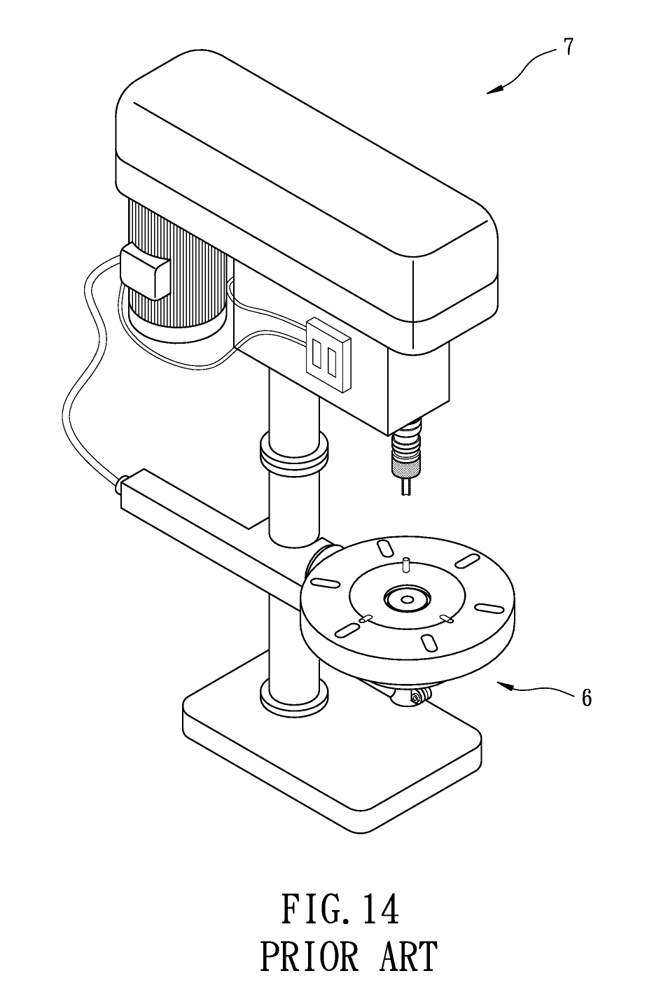

With reference to FIG. 12 that shows a forth embodiment of the worktable, in the preferred embodiment of the present invention, an axle sleeve 131 is sleeved on the spindle 13 for changing different diameter sizes for various drilling machines and increasing the adaptability of the assembly of the mechanism. A lower part of the axle sleeve 131 is installed in the working arm 301 for adapting to be connected to the drilling machine.

However, above mentioned embodiments are just examples of the present invention, they are not confined the scope of the present invention.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A locking mechanism of a worktable for a drilling machine, said mechanism comprising:
a worktable;
a loading surface formed on a top of the worktable for loading, a space defined in the worktable and a wire coil received therein for producing a electromagnetic field;
a spindle longitudinally and centrally mounted to a bottom of the worktable for assembling a drilling machine; and
a connecting portion mounted onto a periphery of the spindle and including a locating assembly and a conducting assembly mounted in the locating assembly for electrically connecting the wire coil, the locating assembly having at least one fixing hole defined therein, at least one fixing rod mounted into the fixing hole for fixing the locating assembly and maintaining the electromagnetic field.

2. The locking mechanism of a worktable for a drilling machine as claimed in claim 1, the fixing rod further comprising a locking member diametrically mounted thereon for increasing a fixing effect.

3. The locking mechanism of a worktable for a drilling machine as claimed in claim 1, further comprising an axle sleeve sleeved on the spindle for changing different diameter sizes for various drilling machine.

4. The locking mechanism of a worktable for a drilling machine as claimed in claim 1, the conducting assembly further comprising two conducting rings for electrically connecting the wire coil, and the two conducting rings being insulated relative to each other.

5. The locking mechanism of a worktable for a drilling machine as claimed in claim 1, further comprising a protecting assembly mounted on the locating assembly for protecting two electric wires that are electrically connected to conducting assembly.

6. The locking mechanism of a worktable for a drilling machine as claimed in claim 1, the worktable further comprising a circular coil buried therein and surrounding the wire coil for increasing an effective area of the electromagnetic field.

7. The locking mechanism of a worktable for a drilling machine as claimed in claim 1, the worktable further comprising multiple secondary coils buried therein and equally surrounding the wire coil for increasing an effective area of the electromagnetic field.

8. The locking mechanism of a worktable for a drilling machine as claimed in claim 1, wherein the locating assembly having multiple fixing holes and two of the multiple fixing holes being mounted into by two fixing rods for increasing the adaptability.
